(19) United States
(12) Patent Application Publication
(10) Pub. No.: US 2026/0242543 A1
(43) Pub. Date: Aug. 20, 2026

(54) PREPARATION OF STABLE, PHOTOCURABLE RESIN COMPOSITION FOR HYDROLYTICALLY STABLE, OPTICALLY CLEAR FILM FOR FLEXIBLE DISPLAY APPLICATIONS

(71) Applicant: Ares Materials Inc., Dallas, TX (US)

(72) Inventors: David Arreaga, Garland, TX (US); Sudheendran Mavila, Sachse, TX (US); Adrian Avendano-Bolivar, Prosper, TX (US)

(21) Appl. No.: 19/232,340

(22) Filed: Jun. 9, 2025

(30) Foreign Application Priority Data
Feb. 20, 2025 (JP) 10-2025-0021964
Feb. 20, 2025 (JP) 2025-025474

(51) Int. Cl. C08G 75/045; C08J 5/18; G02B 1/04

(52) U.S. Cl. CPC C08G 75/045; C08J 5/18; G02B 1/04; C08J 2381/02

(57) ABSTRACT

A photocurable resin composition for forming a hydrolytically stable, optically clear film includes a polyfunctional multifunctional thiol monomer having 3 to 5 thiol functional groups, a polyfunctional multifunctional vinyl monomer having 4 or more vinyl/allyl functional groups, and a polyfunctional multifunctional acrylate monomer having 2 or more acrylateoyl functional groups. The photocurable resin composition further includes a photo-initiator present in a concentration of about 1 parts per hundred or less and a sterically hindered phenolic antioxidant present in a concentration of about 5 parts per hundred or less.

### CROSS-REFERENCE TO RELATED APPLICATIONS

This application claims priority to Japanese Patent Application No. 2025-025474, filed February ₂₀1, 2025, and entitled "PREPARATION OF STABLE, PHOTOCURABLE RESIN COMPOSITION FOR HYDROLYTICALLY STABLE, OPTICALLY CLEAR FILM FOR FLEXIBLE DISPLAY APPLICATIONS," and Korean Patent Application No. 10-2025-0021964, filed February 20th, 2025, and entitled "PREPARATION OF STABLE, PHOTOCURABLE RESIN COMPOSITION FOR HYDROLYTICALLY STABLE, OPTICALLY CLEAR FILM FOR FLEXIBLE DISPLAY APPLICATIONS," both of which claim priority to United States Provisional Patent Application No. 63/556,326, filed February 21st, 2024, the entire disclosures of which are incorporated herein by reference for all purposes.

### BACKGROUND

The world is witnessing a remarkable trend in the evolution of lighter, thinner, more stretchable, and flexible plastic-based electronic devices. This trend necessitates significant innovation in material development to cater to these flexible applications.

Current technologies offer a variety of optical films designed to replace rigid substrate materials for flexible display applications. Examples of such materials include polyethylene terephthalate (PET), polybutylene naphthalate (PBN), polyimide (PI), colorless polyimide (CPI), and cyclic olefin polymers (COPs). Though these materials generally possess high transmittance in the visible spectrum and low haze, they fall short of the requirements for optical film applications in image display devices. Problems include high birefringence with PET and PBN, unsatisfactory flexibility of COPs, and complex and expensive manufacturing processes associated with CPI, which yields a yellow film with high birefringence.

Furthermore, the issue of hydrolytic stability of these materials under extreme thermal aging conditions is also a significant concern. Notably, it is a challenging task to maintain desirable optical and thermomechanical properties under high humidity and temperature conditions for prolonged periods.

In terms of chemical structure, many current material formulations make use of multifunctional monomers. However, these often fail to achieve a satisfactory balance between hardness and flexibility. In addition, safety issues can arise due to the presence of residual traces of isocyanates in these monomers, which can be hazardous.

### BRIEF DESCRIPTION OF THE DRAWINGS

For a more complete understanding of the features and advantages of the present disclosure, reference is now made to the detailed description along with the accompanying figures in which corresponding numerals in the different figures refer to corresponding parts and in which:

FIG. 1 is an illustration of a cross-sectional view of an optical laminate in accordance with certain embodiments of the present disclosure; and

FIG. 2, which is an illustration of a cross-sectional view of a flexible display in accordance with certain embodiments of the present disclosure.

The illustrated figures are only exemplary and are not intended to assert or imply any limitation with regard to the environment, architecture, design, or process in which different examples may be implemented.

### DETAILED DESCRIPTION

The present disclosure relates to a stable resin composition for hydrolytically stable, optically clear film for flexible displays. The present disclosure further relates to the field of material sciences, specifically the development of resin compositions. Moreover, the present disclosure relates to the field of flexible display technologies and the creation of optically clear films with enhanced surface hardness and hydrolytic stability.

The trend of lighter, thinner, more stretchable and flexible plastic-based electronic devices has been growing in recent years, demanding significant innovation in material development for this application. Currently, a variety of optical films are available on the market to replace rigid substrate materials for flexible display applications, such as polyethylene terephthalate (PET), polybutylene naphthalate (PBN), polyimide (PI), colorless polyimide (CPI), cyclic olefin polymers (COPs). Even though generally these films have high transmittance in the visible spectrum and low haze, they are still unsatisfactory for optical films applications in image display devices. PET and PBN tend to have high birefringence; the mechanical properties of COPs usually do not meet the flexibility specification of flexible applications; the process to manufacture the CPI is difficult and expensive, while yielding a yellow film with high birefringence. Thus, a photocurable optically clear resin is desirable to produce a flexible optical film with high transparency, low haze, low color, low birefringence, high thermal-, photo-, and hydrolytical stability in a low-cost manufacturing process for image display device.

The present invention addresses the issues discussed in the background by providing a stable, photocurable resin composition for producing hydrolytically stable, optically clear films suitable for flexible display applications. This resin composition is formulated with specific proportions of a multifunctional thiol monomer, multifunctional vinyl monomer, and multifunctional acrylate comonomer, with the addition of photoinitiator and sterically hindered phenolic anti-oxidant. This composition can be photocured with a UV dose as low as 1 J/cm2.

The resulting flexible films showcase high hydrolytic stability under extreme thermal aging conditions and maintain their optical and thermomechanical properties under high humidity and temperature for extended periods. Furthermore, these films demonstrate exceptional optical properties, such as low haze, low yellowing index, and high transmission rate, coupled with excellent hardness and resilience.

Unique to embodiments of the invention is the process of synthesizing multifunctional allyl, vinyl and alkyne monomers using a Tin complex catalyst without the need for a solvent. This orthogonal coupling reaction strategy allows the reaction process to start and conclude in the same reactor without leaving any side product or solvent residues. The multifunctional vinyl monomer created through this thermal coupling contains two urethane groups and a hydrophobic rigid core per molecule, enhancing the overall hydrolytic stability and mechanical properties of the resultant material. With this approach, it is possible to achieve a maximum of 9 allyl functional groups per molecule. As a result, the molecular weight per functional group is low, which creates a uniformly cross-linked polymer network that maintains high hardness and flexibility in film form. By replacing allyl with alkyne, the hardness is significantly improved due to the reduced molecular weight per functional group, which achieves a high cross-link density contributing to the hardness.

Also disclosed in this invention are specific mole ratios of total thiol groups from the multifunctional thiol monomers to the total acrylate groups and vinyl groups from the multifunctional acrylate and vinyl monomers. These ratios contribute to the material's enhanced properties, such as increased tensile strength and balance between hardness and flexibility.

In terms of safety, the invention also addresses potential hazards associated with handling chemicals on a large scale, providing guidelines for safe handling and storage procedures. The invention presents a significant advancement in the field of flexible display technologies by providing a solution to existing challenges and improving both the performance and safety aspects of optical film materials.

Provided here are the preparation of stable, photocurable resin composition for hydrolytically stable, optically clear film for flexible display applications. The resin composition comprises of about 20-50 wt. % of a multifunctional thiol monomer, about 20-50 wt. % of multifunctional vinyl monomer and 10-60 wt. % of multifunctional acrylate comonomer, less than 3 parts by hundred photoinitiator and less than 1 parts by hundreds of sterically hindered phenolic anti-oxidant that can be photocured with a UV dose as low as 1 J/cm2. These flexible films possess high hydrolytic stability under extreme thermal aging conditions and are able to maintain the optical and thermomechanical properties under 65°C and 90% humidity for at least 500 h. The flexible polymeric film exhibited excellent optical properties with haze < 1%, YI <1 and transmission >90% with good resilience.

The present disclosure describes a hydrolytically stable, optically clear film produced from a photocurable, optically clear resin composition comprising multifunctional thiol monomers and multifunctional acrylate and vinyl comonomers. The optically clear resin is photocurable by actinic radiation curing to obtain a flexible, optically clear film with a transmittance greater than or equal to>90% within the visible spectrum, a yellowing index of less than or equal to< 1, and an optical haze less than or equal to< 1%., and are The film is able to survive accelerated thermal aging conditions for 500 hours under conditions of 65 °C and 95% relative humidity. The film also exhibits excellent thermal stability with a T_{g} greater than or equal to> 100 °C and a Ts% at greater than or equal to>320 °C.

Provided in this disclosure are examples of photocurable resin compositions for forming hydrolytically stable optical films. The optically clear photocurable resin composition comprises of one multifunctional thiol monomer bearing comprising three or more functional groups, a multifunctional vinyl monomer comprises comprising of three or more vinyl/allyl functional groups, a multifunctional acrylate monomer comprising of two or more acrylate functional groups, a photo-initiator present in a concentration of about 1 parts per hundred or less, a sterically hindered phenolic antioxidant present in a concentration of about 5 parts per hundred or less.

The multifunctional vinyl monomer is synthesized in one-pot using a Tin complex catalyst without using any solvent via a completely orthogonal coupling reaction strategy. Optionally, this may be a "one-pot" process where the reaction process is started and concluded in the same reactor. This process leaving no side product or solvent residues. The multifunctional vinyl monomer formed by thermal coupling contains two urethane groups and a hydrophobic rigid core per molecule.

The mole ratio of total thiol groups from the multifunctional thiol monomers to the total acrylate groups from the multipolyfunctional acrylate monomers may be greater than 0.2. The mole ratio of total thiol groups from the multifunctional thiol monomers and that of to the total vinyl groups from the multipolyfunctional vinyl monomers may be greater than or equal to 1.

An optical film formed by the actinic radiation curing of a photocurable resin is provided. The optical film comprises a multifunctional thiol monomer bearing three or more functional groups, a multifunctional vinyl monomer comprises of three or more vinyl/allyl functional groups, a multifunctional acrylate monomer comprises of two or more acrylate functional groups, a photo-initiator present in a concentration of about 1 parts per hundred or less, a sterically hindered phenolic antioxidant present in a concentration of about 5 parts per hundred or less.

Additionally or alternatively, the optical film may include one or more of the following features individually or in combination. The optically clear resin formulation upon curing may yield a cured ternary polymer with a modulus greater than 2 GPa at 25°C. The optically clear resin composition may yield a cured ternary polymer with a glass transition temperature above 100°C.

In the synthesis process, multifunctional isocyanates are directly combined with alcohols that contain one or more vinyl/allyl/propargyl groups, typically using a catalyst. Urethanes have the ability to form internal secondary interactions that result in better mechanical properties, such as increased tensile strength. These urethane monomers contain a rigid, hydrophobic core structure that improves their hydrolytic stability and mechanical properties. Aliphatic urethanes are generally heat and chemical-resistant, but temperatures above 150°C may cause dissociation and bond exchange.

Using multifunctional monomers with low molecular weight per functional group (such as allyl/vinyl) can enhance the cross-link density and improve the stiffness of materials. However, higher hardness is not solely determined by functionality, as the structure of the monomer (such as rigid cores) also plays a role in determining both hardness and flexibility. Based on our research, we found that using monomers with the functionality of more than three and a MW per functional group of <150g/mol can significantly improve hardness.

It can be difficult to maintain flexibility while increasing hardness in materials with tunable properties. These materials should perform better than traditional polyacrylate-based hardcoats in terms of flexibility and hydrolytic stability.

Once synthesized, these monomers are safe and stable under normal conditions. However, it's important to note that they may contain traces of isocyanates, which can be hazardous. When handling these chemicals on a large scale, it's crucial to use proper personal protective equipment to ensure safety. Ideally, these monomers should be stored under an inert atmosphere if stored for a longer period of time.

In one or more embodiments, a method is provided for preparing a photocurable resin composition of any of the disclosed embodiments by reacting the photocurable resin composition and curing the photocurable resin composition to produce a hydrolytically stable, optically clear film.

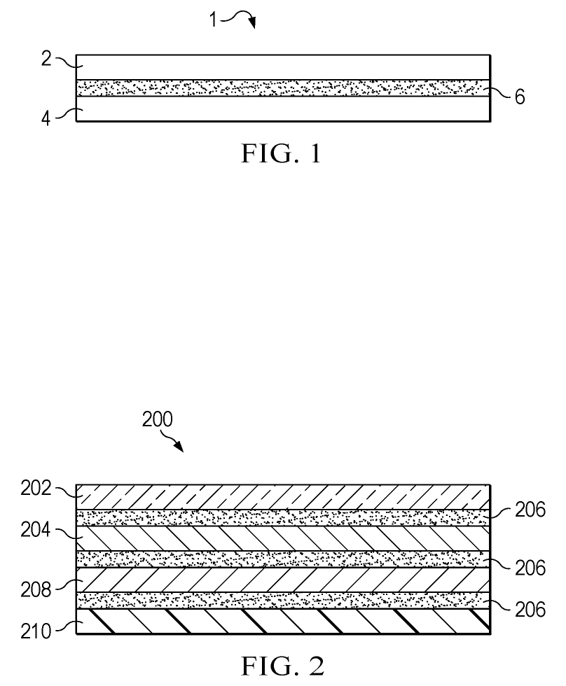

FIG. 1 is an illustration of a cross-sectional view of an optical laminate 1 in accordance with certain embodiments of the present disclosure. As shown, optical laminate 1 includes an adhesive layer 6 including a photocurable resin positioned between and in contact with a first surface of a first base layer 2 and a second surface of a second base layer 4. Adhesive layer 6 may be in direct contact with the first surface of the first base layer 2 and the second surface of the second base layer 4. In other embodiments, adhesive layer 6 may be in indirect contact with the first surface of the first base layer 2 and the second surface of the second base layer 4, where one or more additional layers (not depicted) are positioned between adhesive layer 6 and the first surface of the first base layer 2 and between adhesive layer 6 and the second surface of the second base layer 4. The additional layers may include layers such as, but not limited to, hard coat layers, primer layers, polarizing layers, light emitting layers, or color filter layers. It is further noted that adhesive layer 6 may comprise any embodiment of a photocurable resin disclosed herein.

FIG. 2 is an illustration of a cross-sectional view of a flexible display 200 in accordance with certain embodiments of the present disclosure. As shown, flexible display 200 includes a plurality of layers generally associated with a flexible display and includes a window layer 202, a polarizer layer 204, a display layer 208, and a support film layer 210. An adhesive layer 206 including a photocurable resin is positioned between each pair of layers (202/204, 204/208, and 208/210). More specifically, one adhesive layer 206 of a plurality of adhesive layers 206 is positioned between and in contact with a first surface of window layer 202 and a first surface of polarizer layer 204, another adhesive layer 206 is positioned between and in contact with a second surface of polarizer layer 204 and a first surface of display layer 208, and another adhesive layer 206 is positioned between and in contact with a second surface of display layer 208 and a first surface of support film layer 210.

In other embodiments, adhesive layers 206 may be in indirect contact with the first surface of window layer 202, the first surface of polarizer layer 204, the second surface of polarizer layer 204, the first surface of display layer 208, the second surface of display layer 208, and the first surface of support film layer 210, where one or more additional layers (not depicted) are positioned between adhesive layers 206 and the first surface of window layer 202, the first surface of polarizer layer 204, the second surface of polarizer layer 204, the first surface of display layer 208, the second surface of display layer 208, and the first surface of support film layer 210. The additional layers may include layers such as, but not limited to, hard coat layers, primer layers, polarizing layers, light emitting layers, or color filter layers. It is noted that adhesive layers 206 may comprise any embodiment of a photocurable resin disclosed. It is additionally noted that additional layers that are utilized in a flexible display and are separated by additional adhesive layers 206 can be included in the embodiment of flexible display 200, which can be recognized and understood by one skilled in the art.

In any of the disclosed embodiments, each of adhesive layer 6/adhesive layers 206 may comprise a thickness between 25 m and 500 m. In an embodiment, each of adhesive layer 6/adhesive layers 206 may comprise a thickness of 50 m.

One or more embodiments of this disclosure present materials for constructing higher quality and higher performing flexible display technologies in relation to other flexible display technologies.

It is noted that the photocurable resins presented herein may be utilized in a display/display device/display panel that may be flexible or inflexible. The photocurable resins may be incorporated into one or more layers of the display/display device/display panel that include, but are not limited to: a seal layer, a cathode layer, an emissive layer, an adhesive layer, a conductive layer, an anode layer, a substrate layer, and any layers mentioned in reference to FIG. 2. It is understood that the display/display device/display panel may include additional film layers that are not mentioned herein.

In an embodiment of the present disclosure, an electronic device may be provided that may utilize one or more photocurable resins of the present disclosure in a display/display device/display panel associated with the electronic device. For exemplary purposes, the electronic device may be any of: a smart phone, a mobile phone, a video phone, a camera, a wearable device (such as electronic clothing, an electronic accessory, a smart watch, a head-mounted apparatus, an electronic bracelet, an electronic necklace, or an electronic tattoo), a personal digital assistant (PDA), a desktop computer (PC), a laptop PC, a netbook PC, a portable multimedia player (PMP), a digital audio player, a mobile medical apparatus, an e-book reader, etc. In additional embodiments, electronic device may be a smart home appliance including a display/display device/display panel. For exemplary purposes, the smart home appliance may be any of: an electronic key, a stereo, a TV, a set-top box, a television (TV) box, a video recorder, a game console, a vacuum cleaner, a digital video disk (DVD) player, a refrigerator, an air conditioner, an oven, a dryer, an air purifier, a microwave oven, a washing machine, an electronic dictionary, an electronic photo frame, etc.

The example systems, methods, and acts described in the embodiments presented previously are illustrative, and, in alternative embodiments, certain acts can be performed in a different order, in parallel with one another, omitted entirely, and/or combined between different example embodiments, and/or certain additional acts can be performed, without departing from the scope and spirit of various embodiments. Accordingly, such alternative embodiments are included in the description herein.

As used herein, the singular forms "a", "an" and "the" are intended to include the plural forms as well, unless the context clearly indicates otherwise. It will be further understood that the terms "comprises" and/or "comprising," when used in this specification, specify the presence of stated features, integers, steps, operations, elements, and/or components, but do not preclude the presence or addition of one or more other features, integers, steps, operations, elements, components, and/or groups thereof. As used herein, the term "and/or" includes any and all combinations of one or more of the associated listed items. As used herein, phrases such as "between X and Y" and "between about X and Y" should be interpreted to include X and Y. As used herein, phrases such as "between about X and Y" mean "between about X and about Y." As used herein, phrases such as "from about X to Y" mean "from about X to about Y."

The above-disclosed embodiments have been presented for purposes of illustration and to enable one of ordinary skill in the art to practice the disclosure, but the disclosure is not intended to be exhaustive or limited to the forms disclosed. Many insubstantial modifications and variations will be apparent to those of ordinary skill in the art without departing from the scope and spirit of the disclosure. The scope of the claims is intended to broadly cover the disclosed embodiments and any such modification. Further, the following clauses represent additional embodiments of the disclosure and should be considered within the scope of the disclosure:

Clause 1, a photocurable resin composition for forming a hydrolytically stable, optically clear film, the photocurable resin composition comprising: a polyfunctional multifunctional thiol monomer comprising 3 to 5 thiol functional groups; a polyfunctional multifunctional vinyl monomer comprising 4 or more vinyl/allyl functional groups; a polyfunctional multifunctional acrylate monomer comprising 2 or more acrylateoyl functional groups; a photo-initiator present in a concentration of 1 parts per hundred or less; and a sterically hindered phenolic antioxidant present in a concentration of 5 parts per hundred or less.

Clause 2, the photocurable resin composition of Clause 1, wherein the hydrolytically stable, optically clear film formed from the above photocurable resin composition yields an optically clear resin mixture with a viscosity in the range of 500-2000 CPs.

Clause 3, the photocurable resin composition of Clause 1, wherein the polyfunctional multifunctional vinyl/allyl monomer comprising a rigid hydrophobic core structure per monomer.

Clause 4, the photocurable resin composition of Clause 1, further comprising two urethane functional groups per monomer.

Clause 5, the photocurable resin composition of Clause 4, wherein the urethane functional groups are formed by one-pot solvent free reaction using a Tin catalyst or by catalyst free thermal alcohol-isocyanate coupling reaction with no further purification.

Clause 6, an optically clear resin composition, wherein a monomer mixture undergoes orthogonal reactions to form one or more highly functional comonomers and after which another reaction occurs to form thermoset networks containing polyurethane and polysulfide segments.

Clause 7, a hydrolytically stable, optically clear film, formed by the actinic radiation curing of the photocurable resin composition as in Clause 1.

Clause 8, an optical film, formed by the actinic radiation curing of a photocurable resin comprising: a polyfunctional thiol monomer comprising 3 or more thiol functional groups, a polyfunctional ene monomer comprising 4 or more vinyl/allyl functional groups, a polyfunctional acrylate monomer comprising 2 or more acryloyl functional groups, a photo-initiator present in a concentration of 1 parts per hundred or less, a sterically hindered phenolic antioxidant present in a concentration of 5 parts per hundred or less.

Clause 9, the optical film of Clause 8, wherein the polyfunctional acrylate, vinyl and thiol monomers yield a cured network polymer with a modulus greater than 1 GPa at 20°C.

Clause 10, the optical film of Clause 8, wherein the polyfunctional acrylate, vinyl and thiol monomers yield a cured polymer film with a glass transition temperature above 100°C.

Clause 11, the optical film of Clause 8, wherein the polyfunctional acrylate, vinyl and thiol monomers yield a cured network polymer with a Marten's hardness greater than 210 MPa.

Clause 12, the optical film of Clause 8, wherein the polyfunctional acrylate, vinyl and thiol monomers yield a cured polymer film with more than SOh of thermal aging stability under accelerated 65 C and 90 relative humidity.

Clause 13, the optical film of Clause 8, wherein the polyfunctional acrylate, vinyl and thiol monomers yield a cured polymer film with more than 200,000 cycles of physical aging stability at 50 m thickness and 2mm bending radius under ambient conditions.

Clause 14, the optical film of Clause 8, wherein the polyfunctional acrylate, vinyl and thiol monomers yield a cured 30 m thick polymer film with more than 200,000 cycles of physical aging stability at 1 mm and 2mm bending radius under ambient conditions.

Clause 15, the optical film of Clause 8, wherein the mole ratio of total thiol groups from the polyfunctional thiol monomers to the total vinyl groups from the polyfunctional vinyl monomers is greater than 1.

Clause 16, the optical film of Clause 8, wherein the mole ratio of total thiol groups from the polyfunctional thiol monomers to the total acrylate groups from the polyfunctional acrylate monomers is greater than 0.2.

Clause 17, the optical film of Clause 8, wherein the total concentration of hydrolysable ester functionalities is <25 wt.%.

Clause 18, the optical film of Clause 8, wherein the polyfunctional acrylate, vinyl and thiol monomers yield a cured network polymer with high adhesion to various substrates.

Clause 19, a display film comprising: an optical film formed by curing a photocurable resin, wherein the photocurable resin comprises: a polyfunctional thiol monomer comprising 3 or more thiol functional groups, a polyfunctional ene monomer comprising 4 or more vinyl/allyl functional groups, a polyfunctional acrylate monomer comprising 2 or more acryloyl functional groups, a photo-initiator present in a concentration of 1 parts per hundred or less, a sterically hindered phenolic antioxidant present in a concentration of 5 parts per hundred or less.

Clause 20, a method for preparing the photocurable resin composition of Clause 1 by reacting the photocurable resin composition and curing the photocurable resin composition to produce the hydrolytically stable, optically clear film of Clause 1.

What is claimed is:

1. A photocurable resin composition for forming a hydrolytically stable, optically clear film, the photocurable resin composition comprising:
a polyfunctional multifunctional thiol monomer comprising 3 to 5 thiol functional groups;
a polyfunctional multifunctional vinyl monomer comprising 4 or more vinyl/allyl functional groups;
a polyfunctional multifunctional acrylate monomer comprising 2 or more acrylateoyl functional groups;
a photo-initiator present in a concentration of about 1 parts per hundred or less; and
a sterically hindered phenolic antioxidant present in a concentration of about 5 parts per hundred or less.

2. The photocurable resin composition of claim 1, wherein the hydrolytically stable, optically clear film formed from the above photocurable resin composition yields an optically clear resin mixture with a viscosity in the range of 500-2000 CPs.

3. The photocurable resin composition of claim 1, wherein the polyfunctional multifunctional vinyl/allyl monomer comprising a rigid hydrophobic core structure per monomer.

4. The photocurable resin composition of claim 1, further comprising two urethane functional groups per monomer.

5. The photocurable resin composition of claim 4, wherein the urethane functional groups are formed by one-pot solvent free reaction using a Tin catalyst or by catalyst free thermal alcohol-isocyanate coupling reaction with no further purification.

6. An optically clear resin composition, wherein a monomer mixture undergoes orthogonal reactions to form one or more highly functional comonomers and after which another reaction occurs to form thermoset networks containing polyurethane and polysulfide segments.

7. A hydrolytically stable, optically clear film, formed by the actinic radiation curing of the photocurable resin composition as in claim 1.

8. An optical film, formed by the actinic radiation curing of a photocurable resin comprising: a polyfunctional thiol monomer comprising 3 or more thiol functional groups, a polyfunctional ene monomer comprising 4 or more vinyl/allyl functional groups, a polyfunctional acrylate monomer comprising 2 or more acryloyl functional groups, a photo- initiator present in a concentration of about 1 parts per hundred or less, a sterically hindered phenolic antioxidant present in a concentration of about 5 parts per hundred or less.

9. The optical film of claim 8, wherein the polyfunctional acrylate, vinyl and thiol monomers yield a cured network polymer with a modulus greater than 1 GPa at 20°C.

10. The optical film of claim 8, wherein the polyfunctional acrylate, vinyl and thiol monomers yield a cured polymer film with a glass transition temperature above 100°C.

11. The optical film of claim 8, wherein the polyfunctional acrylate, vinyl and thiol monomers yield a cured network polymer with a Marten's hardness greater than 210 MPa.

12. The optical film of claim 8, wherein the polyfunctional acrylate, vinyl and thiol monomers yield a cured polymer film with more than SOh of thermal aging stability under accelerated 65 C and 90 relative humidity.

13. The optical film of claim 8, wherein the polyfunctional acrylate, vinyl and thiol monomers yield a cured polymer film with more than 200,000 cycles of physical aging stability at 50 m thickness and 2mm bending radius under ambient conditions.

14. The optical film of claim 8, wherein the polyfunctional acrylate, vinyl and thiol monomers yield a cured 30 m thick polymer film with more than 200,000 cycles of physical aging stability at 1 mm and 2mm bending radius under ambient conditions.

15. The optical film of claim 8, wherein the mole ratio of total thiol groups from the polyfunctional thiol monomers to the total vinyl groups from the polyfunctional vinyl monomers is greater than 1.

16. The optical film of claim 8, wherein the mole ratio of total thiol groups from the polyfunctional thiol monomers to the total acrylate groups from the polyfunctional acrylate monomers is greater than 0.2.

17. The optical film of claim 8, wherein the total concentration of hydrolysable ester functionalities is <25 wt.%.

18. The optical film of claim 8, wherein the polyfunctional acrylate, vinyl and thiol monomers yield a cured network polymer with high adhesion to various substrates.

19. A display film comprising: an optical film formed by curing a photocurable resin, wherein the photocurable resin comprises: a polyfunctional thiol monomer comprising 3 or more thiol functional groups, a polyfunctional ene monomer comprising 4 or more vinyl/allyl functional groups, a polyfunctional acrylate monomer comprising 2 or more acryloyl functional groups, a photo-initiator present in a concentration of about 1 parts per hundred or less, a sterically hindered phenolic antioxidant present in a concentration of about 5 parts per hundred or less.

20. A method for preparing the photocurable resin composition of claim 1 by reacting the photocurable resin composition and curing the photocurable resin composition to produce the hydrolytically stable, optically clear film of claim 1.
